(19) United States
(12) Patent Application Publication
(10) Pub. No.: US 2020/0008152 A1
(43) Pub. Date: Jan. 2, 2020

(54) Mitigating a Power Condition Through Deactivation of High-Bandwidth Data Transmissions

(71) Applicant: Google LLC, Mountain View, CA (US)

(72) Inventors: Erik Richard Stauffer, Sunnyvale, CA (US); Jibing Wang, Sunnyvale, CA (US)

(73) Assignee: Google LLC, Mountain View, CA (US)

(21) Appl. No.: 16/023,262

(22) Filed: Jun. 29, 2018

(51) Int. Cl. H04W 52/02; H04W 76/30

(52) U.S. Cl. CPC H04W 52/0238; H04W 76/15; H04W 76/30; H04W 52/0274

(57) ABSTRACT

The present disclosure describes techniques and systems to mitigate a power condition local to a user device by deactivating high-bandwidth transmission of data to the user device. While receiving multiple streams of data as part of high-bandwidth wireless communications, the user device determines a local power condition and sends a deactivation message that causes a base station to deactivate transmission of at least one of the multiple streams of data.

### BACKGROUND

Wireless communication technology providers have, on a continual basis, introduced enhancements to wireless communication technologies to improve data transfer rates between a user device and a wireless network. As an example, Third-Generation Long-Term Evolution (3G LTE) wireless communication technology providers developed systems to support data transfer rates of 200 kilobits/sec (kb/s). Fifth-Generation New Radio (5G NR) wireless communication technology providers have, however, introduced enhancements that have improved data transfer rates to nearly 10,000 kb/s.

For example, enhancements include improvements in hardware of the user device, as well as base stations supporting the wireless network, to allow wireless communications of data using higher frequencies. Where LTE-compatible hardware operates at frequencies approaching 2 Gigahertz (GHz), 5G NR-compatible hardware operates at frequencies in excess of 15 GHz.

Enhancements also include the introduction of carrier aggregation (CA) techniques, allowing the user device to receive and aggregate multiple streams of data. In some instances, the multiple streams of data may originate from a single base station using different bandwidth parts (BWP) of a frequency range. In other instances, the multiple streams of data may originate from different, respective base stations via multi-connectivity.

When receiving and aggregating the multiple streams of data, however, power consumption associated with receiving and processing the multiple streams of data by the user device may elevate the temperature of the user device and introduce negative effects. Such negative effects may include, for example, a shortened battery life, the user device invoking a low-power state and inadvertently weakening a strength of a signal transmitted from the user device, the user device locking a user from accessing features of the user device until it cools, or the like.

In general, today carrier aggregation (CA) techniques rely on a base station of a wireless network managing the transmission of the multiple streams of data. In one example instance, the base station may, based on unused capacity of the base station as well as data queries from the user device, allocate differing bandwidth parts for a wireless link between the base station and the user device to transmit multiple, respective streams of data. In another instance and as another example to satisfy data queries of the user device, the base station may communicate with other base stations that also supports the wireless network to initiate multi-connectivity with the user device, wherein the base station and the other base stations combine to transmit multiple, respective streams of data via respective wireless links.

The example instances give rise to carrier aggregation on behalf of the user device. However, in the example instances, the base station and the other base stations are both ignorant of power conditions that the user device may experience and, as such, are unaware of compromises in performance that may manifest at the user device. In such instances, continuing high-bandwidth data transmissions may lead to a compromise in effectiveness and efficiencies of wireless communications as a whole.

### SUMMARY

The present disclosure describes techniques and systems to mitigate a power condition local to a user device by deactivating high-bandwidth transmission of data to the user device. While receiving multiple streams of data as part of high-bandwidth wireless communications, the user device determines a local power condition and sends a deactivation message that causes a base station to deactivate transmission of at least one of the multiple streams of data.

In some aspects, a method for mitigating a power condition that is local to a user device is described. As part of the method, a user device receives a first data stream transmitted from a first base station to which the user device is wirelessly connected via a first wireless link. The user device also receives a second data stream transmitted from a second base station to which the user device is wirelessly connected via a second wireless link. After determining a local power condition based on the receiving of the first and second data streams, the user device then sends a deactivation message that causes the second base station to deactivate the transmission of the second data stream, resulting in mitigation of the determined, local power condition.

In some other aspects, a method for mitigating a power condition that is local to a user device is described. As part of the method, the user device is wirelessly connected to a base station and receives a first data stream transmitted by the base station via a first frequency band comprising a first set of resources available to the base station. The user device receives a second data stream transmitted by the base station via a second frequency band comprising a second set of resources available to the base station. After determining a local power condition based on the user device receiving the first and second data streams, the user device sends a deactivation message that causes the base station to deactivate the transmission of the second data stream, resulting in mitigation of the determined, local power condition.

In further aspects, a user device is described. The user device comprises a transceiver, detection circuitry, a processor, and computer-readable storage media comprising instructions to implement a power-condition manager application. The power-condition manager application configured to causes the user device to receive, via the transceiver, a first data stream and a second data stream and then determine, via the detection circuitry and based on receiving the first and second data streams, a power condition that is local to the user device. The power-condition manager application then causes the user device to send, to a source of the second data stream, a deactivation message, where the deactivation message causes the source to deactivate transmission of the second data stream, resulting in a mitigation of the power condition that is local to the user device.

The power-condition manager application, when executed by the processor of the user device, provides a means for the user device to receive the first and second data streams, determine a power condition that is local to the user device, and cause a deactivation of the second data stream.

The details of one or more implementations are set forth in the accompanying drawings and the following description. Other features and advantages will be apparent from the description and drawings, and from the claims. This summary is provided to introduce subject matter that is further described in the Detailed Description and Drawings. Accordingly, a reader should not consider the summary to describe essential features nor limit the scope of the claimed subject matter.

### BRIEF DESCRIPTION OF THE DRAWINGS

This document describes details of one or more aspects of mitigating a power condition local to a user device by deactivating high-bandwidth transmission of data to the user device. The use of the same reference numbers in different instances in the description and the figures may indicate like elements:

FIG. 1 illustrates an example operating environment in which various aspects of mitigating a power condition by deactivating high-bandwidth transmission of data can be implemented.

FIG. 2 illustrates example details of mitigating a power condition by deactivating high-bandwidth transmission of data as associated with data streams transmitted via multi-connectivity technology.

FIG. 3 illustrates an air interface resource that extends between a user device and a base station applicable to deactivating high-bandwidth transmission of data as associated with data streams transmitted via differing bandwidth parts of a wireless link.

FIG. 4 illustrates example features of a user device that, as presented through a graphical user interface of the user device, enables a user to manage high-bandwidth data communications.

FIG. 5 illustrates details of example data and control transactions between devices in accordance with aspects of mitigating a power condition by deactivating high-bandwidth transmission of data.

FIG. 6 illustrates an example method of mitigating a power condition that is local to a user device as generally related to high-bandwidth transmission of data through multi-connectivity technology.

FIG. 7 illustrates an example method of mitigating a power condition that is local to a user device as generally related to high-bandwidth transmission of data relying on differing bandwidth parts of a wireless link.

### DETAILED DESCRIPTION

The present disclosure describes techniques and systems to mitigate a power condition local to a user device by deactivating high-bandwidth transmission of data to the user device. A user device receiving and aggregating multiple streams of data as part of high-bandwidth wireless communications may determine, via detection circuitry of the user device, a power condition local to the user device. In order to mitigate the power condition, the user device may then communicate with sources of the multiple streams of data (e.g., one or more base stations) and, via deactivation messaging, cause the sources to deactivate transmissions of one or more streams of the multiple streams of data.

While features and concepts of the described systems and methods for a mitigating a power condition resulting from a user device receiving multiple streams of data can be implemented in any number of different environments, systems, devices, and/or various configurations, aspects of mitigating the power condition are described in the context of the following example devices, systems, and configurations.

Operating Environment

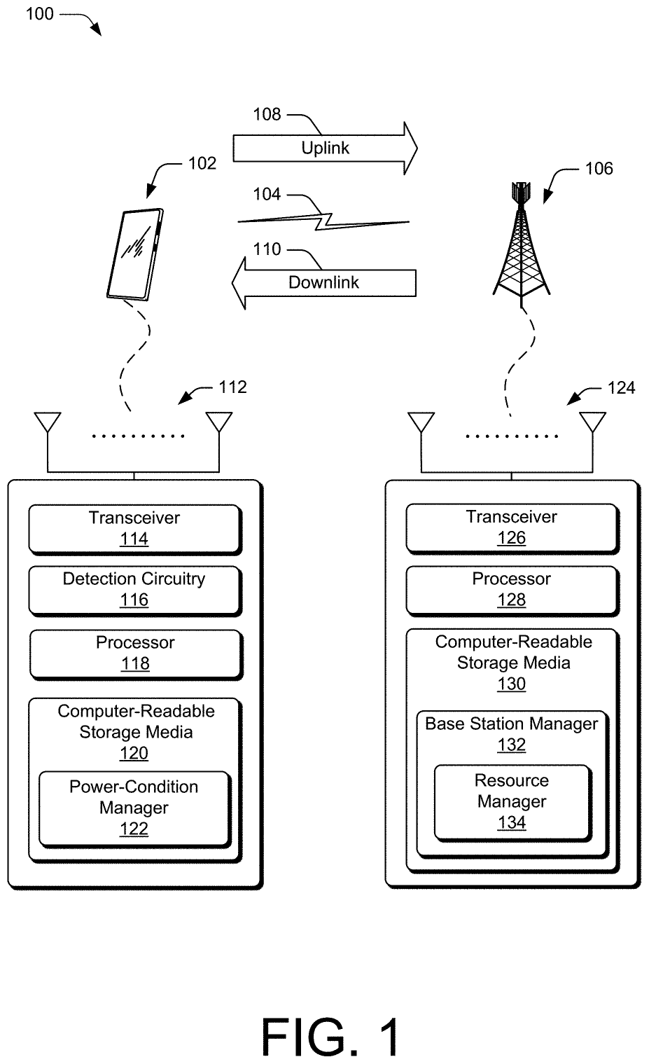

FIG. 1 illustrates an example operating environment 100 in which various aspects of mitigating a power condition by deactivating high-bandwidth transmission of data can be implemented. The operating environment 100 includes a user device 102 connecting via a wireless link 104 to a base station 106. It should be noted that only the features of the user device 102, the wireless link 104, and the base station 106 related to the techniques described herein are illustrated here for the sake of clarity.

In this example, the user device 102 is implemented as a smartphone. Although illustrated as a smartphone, the user device 102 be implemented as any suitable computing or electronic device, such as a mobile communication device, a user equipment (UE), a modem, cellular phone, gaming device, navigation device, media device, laptop computer, desktop computer, tablet computer, smart appliance, vehicle-based communication system, and the like. The base station 106 (e.g., an Evolved Universal Terrestrial Radio Access Network Node B, E-UTRAN Node B, evolved Node B, eNodeB, eNB, Next Generation Node B, gNode B, gNB, and the like) may be implemented in a macrocell, microcell, small cell, picocell, and the like, or any combination thereof.

The wireless link 104 supports uplink (UL) and downlink (DL) communications between the user device 102 and the base station 106. The wireless link 104 may include one or more wireless links or bearers implemented using any suitable communication protocol or standard, or combination of communication protocols or standards such as 3rd Generation Partnership Project Long-Term Evolution (3GPP LTE), 5G NR, and so forth. The wireless link 104 comprises resources of an air interface that are dedicated to carrying data or messages between the user device 102 and the base station 106 via an uplink 108 and a downlink 110. For example, the uplink 108 may carry a Resource Control (RRC) message, a Medium Access Control Element (MAC CE) message, an Uplink Control Information (UCI) message, or a Buffer Status Report message from the user device 102 to the base station 106. As another example, the downlink may carry a Downlink Control Information (DCI) message.

The user device 102 may connect to a core network (e.g., a public network provided by a network service provider) through the base station 106 via the wireless link 104. The core network may include, for example, routers, servers, other base stations, or communication hardware that enable the user device 102 to communicate and exchange data with other user devices. In certain instances, the exchange of data may include high-bandwidth transmission of data from the base station 106 to the user device 102. High-bandwidth data transmission may include the base station 106 transmitting multiple streams of data using one or more of a variety of techniques, including techniques that use transmit the multiple streams of data using different bandwidth parts (BWP) of resources available to the base station to simultaneously transmit multiple streams of data.

The user device 102 includes a Multiple Input Multiple Output (MIMO) antenna array 112 and a transceiver 114. The transceiver 114 may be, for example, an LTE transceiver or a 5G NR transceiver. The MIMO antenna array 112 can be tuned to, and/or be tunable to, one or more frequency bands defined by the LTE and 5G NR communication standards and implemented by the transceiver 114. The MIMO antenna array 112 and the transceiver 114 may receive multiple streams of data in support of carrier aggregation operations performed by the user device 102.

Also included it the user device 102 is detection circuitry 116 which may aid in determining a power condition that the user device experiences. Such detection circuitry may include circuitry that detects, for example, an electrical-current draw from a power source of the user device 102, a temperature of the user device 102, a weak transmission signal of the user device 102, or the like.

The user device 102 also includes a processor 118. The processor 118 may be a single core processor or a multiple core processor composed of a variety of materials, such as silicon, polysilicon, high-K dielectric, copper, and so on. In general, when the user device is performing carrier aggregation operations (e.g., receiving the multiple streams of data), activities associated with the processor 118 may be elevated, drawing power from a power source of the user device 102 and generating a power condition local to the user device.

The user device 102 also includes computer-readable storage media 120 (CRM 120). The CRM 120 as described herein excludes propagating signals. The CRM 120 may include any suitable memory or storage device such as random-access memory (RAM), static RAM (SRAM), dynamic RAM (DRAM), non-volatile RAM (NVRAM), read-only memory (ROM), or Flash memory useful to store device data of the user device 102. The CRM 120 includes code or instructions for a power-condition manager 122, which, when executed by the processor 118, causes the user device 102 to perform functions that support activation or deactivation of high-bandwidth data transmission from the base station 106. Such functions may include, for example, sending commands to the base station 106 that cause the base station 106 to activate or deactivate high bandwidth data transmissions, as well as activating or deactivating operations performed local to the user device 102 that receive and combine multiple data streams (e.g., carrier aggregation). Alternately or additionally, the power-condition manager 122 may be implemented in whole or part as hardware logic or circuitry integrated with or separate from other components of the user device 102.

The base station 106 includes a Multiple Input Multiple Output (MIMO) antenna array 124 and a transceiver 126 for communicating with the user device 102. The MIMO antenna array 124 of the base station 106 may include multiple antennas that are configured similar to or differently from each other. The MIMO antenna array 124 can be tuned to, and/or be tunable to, one or more frequency bands defined by the 3GPP LTE and 5G NR communication standards and implemented by the transceiver 126.

The base station 106 includes a processor 128 and computer-readable storage media 130 (CRM 130). The processor 128 may be a single core processor or a multiple core processor composed of a variety of materials, such as silicon, polysilicon, high-K dielectric, copper, and so on. The computer-readable storage media described herein excludes propagating signals. The CRM 130 may include any suitable memory or storage device such as random-access memory (RAM), static RAM (SRAM), dynamic RAM (DRAM), non-volatile RAM (NVRAM), read-only memory (ROM), or Flash memory useful to store device data of the user device 102.

The CRM 130 includes code or instructions for a base station manager 132 which, when executed by the processor, cause the base station 106 to perform functions of activating or deactivating high-bandwidth data transmissions to the user device 102. Activating or deactivating high-bandwidth data transmissions can include, for example, activating or deactivating one or more data streams (of multiple data streams) that might be associated with respective bandwidth parts of an air interface supporting the wireless link 104. The base station manager 132 includes a resource manager 134 which may augment activation and deactivation operations as performed by the base station manager 132. For example, the resource manager 134 may allocate air interface resources for communications between the base station 132 and the user device 102. Alternately or additionally, the base station manager 132 may be implemented in whole or part as hardware logic or circuitry integrated with or separate from other components of the base station 106.

In certain instances, high-bandwidth communications (e.g., high-bandwidth data transmission from the base station 106 to the user device 102) may generate a power condition local to the user device 102. Such a power condition may be determined by the processor 118 of the user device 102 executing the code of power-condition manager 122 and include, for example, determining an electrical-current draw from a power source of the user device 102 exceeds an electrical-current draw threshold, determining a temperature local to the user device 102 (e.g., a system temperature hardware of the user device 102 or a temperature of an ambient condition surrounding the user device 102) exceeds a temperature threshold, or the like. In such an instance, the power-condition manager 122 may cause the user device 102 to send a deactivation message via uplink 108 to the base station 106, where the deactivation message includes data or commands that cause the base station 106 to deactivate high-bandwidth data transmissions. The power-condition manager 122 may also, in certain instances, cause the user device 102 to terminate carrier aggregation operations that the user device 102 is performing local to the user device 102.

Conversely, the power-condition manager 122 may determine that power conditions local to the user device are below certain thresholds (e.g., below an electrical-current draw threshold or a temperature threshold). In such an instance, the power-condition manager 122 may cause the user device 102 to activate carrier aggregation operations and also cause the user device 102 to send an activation message to the base station 106 via the uplink 108, where the activation message is configured by the power-condition manager 122 to include data or commands that cause the base station 106 to activate high-bandwidth data transmissions.

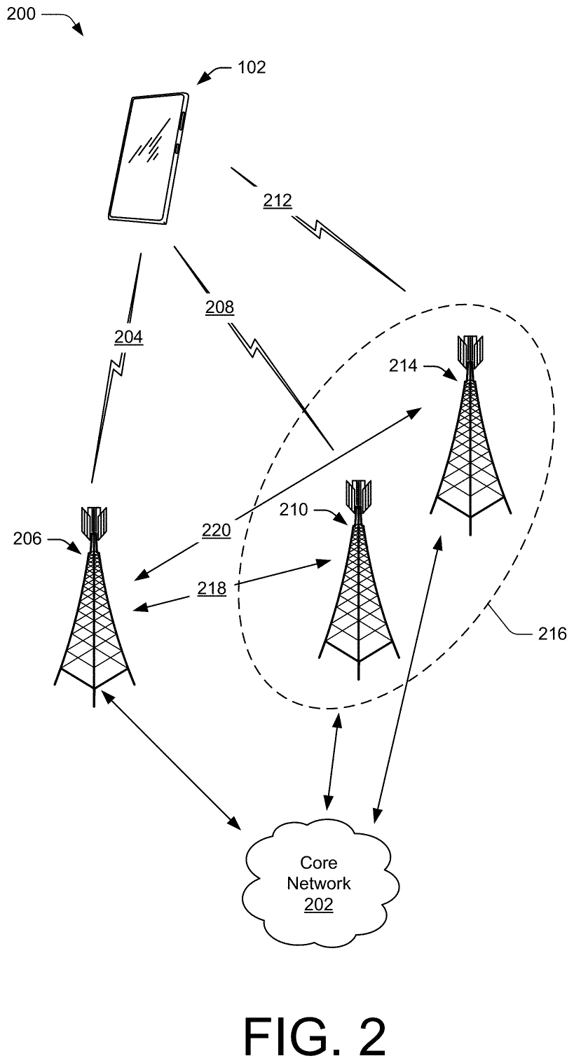

FIG. 2 illustrates example details 200 of mitigating a power condition by deactivating high-bandwidth transmission of data as associated with data streams transmitted via multi-connectivity technology. Multiple features, as illustrated and described by FIG. 1, may be applicable to FIG. 2.

As illustrated in FIG. 2, the user device 102 is receiving and aggregating a high-bandwidth of data. The receiving of high-bandwidth data is a result of connectivity between the user device 102 and a core network 202 via wireless link 204 connecting the user device 102 to multiple nodes supporting the core network 202. This includes connecting the user device 102 to a primary base station 206, via wireless link 208 connecting the user device 102 to a secondary base station 210, and via wireless link 212 connecting the user device 102 to another secondary base station 214.

High-bandwidth data exchange between the user device 102 and the core network 202 may be in accordance with one or more multi-connectivity technologies that include transmitting multiple data streams in accordance with orthogonal multiple access (OMA) transmission protocols, non-orthogonal multiple access (NOMA) transmission protocols, as part of an air interface bandwidth part (BWP), or the like. Multi-connectivity technologies further allow grouping of nodes to communicate in accordance with a communication standard that might be different than another communication standard employed by another node (or grouping of nodes). For example, the illustrated grouping 216 (e.g., the grouping of the secondary base station 210 and the other secondary base station 214) may be communicating with the user device 102 in accordance with an LTE standard while the base station 206 may be communicating with the user device in accordance with a 5G NR standard.

FIG. 2 also illustrates example interfaces between base stations which, in certain instances, allow direct communications amongst the base stations. As illustrated, interface 218 allows direct communication (e.g., direct data exchange) between the primary base station 206 and the secondary base station 210. Also, as illustrated, interface 220 allows direct communication between the primary base station 206 and the other secondary base station 214. The interface 218 and the interface 220 may, in certain instances, be an Xn interface. Furthermore, through allowing direct communication between the primary base station 206 and the secondary base station 210 as well as the other secondary base station 214, the interface 218 and the interface 220 provide a means for the primary base station 206 to communicate data, including deactivation messages, directly to the secondary base station 210 and the other secondary base station 214.

As the user device 102 is performing carrier aggregation operations, the power-condition manager 122 may determine a power condition local to the user device 102 that can be mitigated by deactivating transmissions associated with the multi-connectivity as illustrated by FIG. 2. The power-condition manager 122 may then cause the user device 102 to transmit a deactivation message to one or more of the primary base station 206, the secondary base station 210, and the other secondary base station 214.

Alternatively, the power-condition manager 122 may cause the user device 102 to transmit the deactivation message to only the primary base station 206, which may then relay one or more additional messages to one or more of the secondary base station 210 and the other secondary base station 214 via a direct interface (e.g., the interface 216 or the interface 218, respectively). The one or more additional messages may contain, for example, data or commands that include deactivation configurations as applicable to the secondary base station 210 and the other secondary base station 214, respectively.

In certain instances, the power-condition manager 122 may postpone deactivation of carrier aggregation operations local to the user device 102 until the user device 102 receives deactivation acknowledgement messages from of one or more respective base stations. The user device 102 may receive the deactivation acknowledgment message from the primary base station 206, the secondary base station 210, the other secondary base station 214, or a combination thereof.

The power-condition manager 122 may also perform operations directed to activating high-bandwidth data transmission that might be associated with multi-connectivity technologies. In such instances, communications amongst the user device 102, the primary base station 206, the secondary base station 210, and the other secondary base station 214 may include one or more combinations of other activation messages that include data or commands that cause activation of high-bandwidth data transmissions, activation confirmation messages, activation acknowledgement messages, or the like.

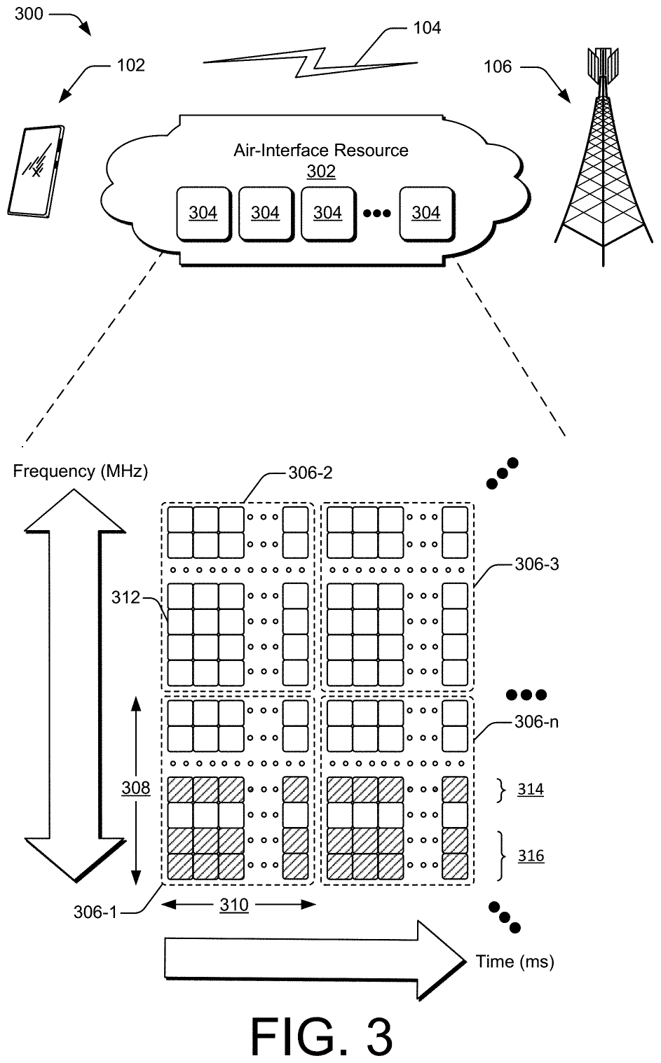

FIG. 3 illustrates an air interface resource that extends between a user device and a base station 300 applicable to deactivating high-bandwidth transmission of data as associated with data streams transmitted via differing bandwidth parts of a wireless link. As illustrated, a resource having different bandwidth parts is in the form of an air-interface resource 302 supporting the wireless link 104 that extends between the user device 102 and the base station 106 of FIG. 1.

The air-interface resource 302 can divided into resource units 304, each of which occupies some intersection of frequency spectrum and elapsed time. A portion of the air-interface resource 302 is illustrated graphically in a grid or matrix having multiple resource blocks 306, including resource blocks 306-1, 306-2, 306-3 . . . 306-n, with “n” representing some positive integer. An example of a resource unit 304 therefore includes at least one resource block 306. As shown, time is depicted along the horizontal dimension as the abscissa axis, and frequency is depicted along the vertical dimension as the ordinate axis. The air-interface resource 302, as defined by a given communication protocol or standard, may span any suitable specified frequency range and/or may be divided into intervals of any specified duration. Increments of time can correspond to, for example, milliseconds (ms). Increments of frequency can correspond to, for example, megahertz (MHz).

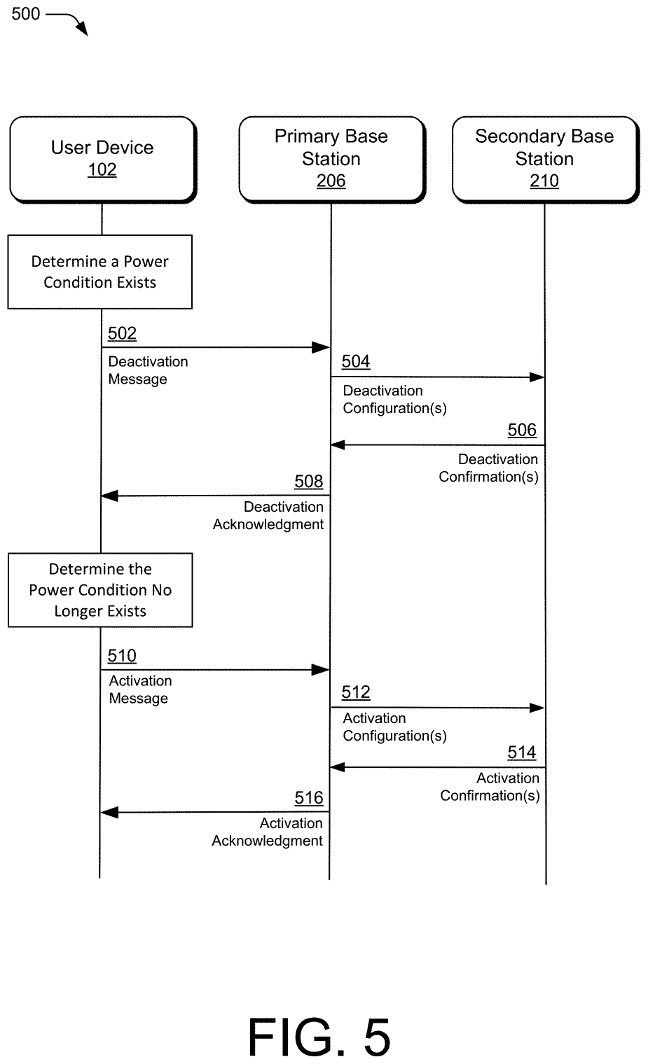

The base station 106 allocates portions of the air-interface resource 302 for uplink and downlink communications associated with the wireless link 104. Each resource block 306 may be allocated to support respective wireless communications of multiple end-user devices. In the lower left corner of the grid, the resource block 306-1 may span, as defined by a given communication protocol, a specified frequency range 308 and comprise multiple subcarriers. The resource block 306-1 may include any suitable number of subcarriers (e.g., 12) that each correspond to a respective portion (e.g., 15 kHz) of the specified frequency range 308 (e.g., 180 kHz). The resource block 306-1 may also span, as defined by the given communication protocol, a specified time interval 310 or time slot (e.g., lasting approximately one-half millisecond or 7 orthogonal frequency-division multiplexing (OFDM) symbols). The specified time interval 310 includes subintervals that may each correspond to a symbol, such as an OFDM symbol. As shown in FIG. 5, each resource block 306 may include multiple resource elements 312 (REs) that correspond to, or are defined by, a subcarrier of the specified frequency range 308 and a subinterval (or symbol) of the specified time interval 310. Alternatively, a given resource element 312 may span more than one frequency subcarrier or symbol. Thus, a resource unit 304 may include at least one resource block 306, at least one resource element 312, and so forth.

As a base station manager (e.g., the base station manager 132 of FIG. 1) is performing deactivation or activation operations, a resource manager (e.g., the resource manager 134 of FIG. 1) may configure a base station 106 to transmit (or not transmit) data streams via respective groups of subcarriers of the air-interface resource 302. As illustrated, and for example, subcarrier group 314 may transmit one data stream while subcarrier group 316 may transmit another data stream. In effect, the subcarrier group 314 and the subcarrier group 316 constitute different, respective bandwidth parts (BWPs) of the air-interface resource 302. As part of deactivation or activation of transmissions from base station 106, the base station manager may configure the base station 106 to transmit (or not transmit) data via the subcarrier group 314 or the subcarrier group 316.

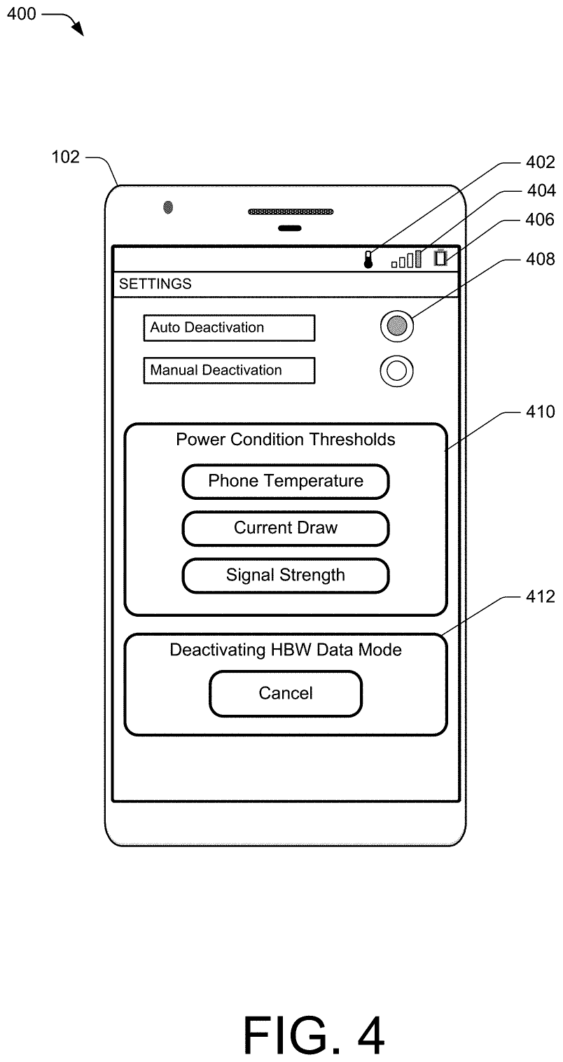

FIG. 4 illustrates example features 400 of a user device that, as presented through a graphical user interface of the user device, enable a user to manage high-bandwidth data communications. The user device may be the user device 102 of FIG. 1 and the illustrated features of FIG. 4 may be applicable to operations or functions illustrated and described by FIGS. 1-3.

FIG. 4 depicts an example graphical user interface (GUI) of the user device 102 that presents settings that are applicable to deactivating a high-bandwidth data mode. In accordance with previous descriptions, deactivation of the high-bandwidth data mode may comprise several functions, including deactivating high-bandwidth data transmissions from one or more base stations that are remote from the user device 102 as well as deactivating carrier aggregation functions that are performed local to the user device 102.

The example, illustrated features include one or more power status indicators, including a temperature indicator 402, a signal strength indicator 404, and a power source indicator 406. The illustrated, example features also include a selectable menu 408 for selecting a mode of deactivation, another selectable menu 408 for viewing or adjusting thresholds associated with the power condition, and yet another selectable menu 410 for canceling deactivation.

Mitigating a Power Condition through Deactivation of High-Bandwidth Data Transmission

FIG. 5 illustrates details 500 of example data and control transactions between devices in accordance with aspects of mitigating a power condition by deactivating high-bandwidth transmission of data. The details 500 of example data and control transactions are illustrated in the context of FIG. 2, in which the user device 102 is receiving multiple data streams transmitted via multi-connectivity technology. The example details 500 are non-limiting, as many permutations of data and control transactions amongst the user device 102 and other devices (e.g., base stations transmitting data to the user device 102 and communicating with one another) are possible.

In response to determining a power condition that is local to the user device 102, the user device may send a deactivation message 502 to the primary base station 206 via the wireless link 204. The deactivation message 502 may be included as part of a Radio Resource Control (RRC) message, a Medium Access Control Element (MAC CE) message, an Uplink Control Information (UCI) message, or a Buffer Status Report message that includes data or commands that cause the primary base station 206 to perform operations that deactivate transmission of one or more data streams to the user device 102. As illustrated in this example, the base station 206 then sends to the secondary base station 210 one or more deactivation configuration messages 504 that configure the secondary base station 210 for deactivation of data transmission. In one example instance, the deactivation configuration message 504 may cause the secondary base station 210 to terminate parallel transmissions of multiple data streams via multiple, corresponding bandwidth parts of an air interface and to initiate transmission of a single data stream via a single bandwidth part of the air interface. In another example instance, the deactivation configuration message may cause the secondary base station 210 to terminate transmission of data altogether.

The base station 206 may send the deactivation configuration message 504 to the secondary base station 210 via an interface such as the interface 218. After configuration is complete, the secondary base station 210 may send, to the primary base station 206 and via the interface 218, a deactivation confirmation message. The primary base station may, in turn, send to the user device a deactivation acknowledgment message 508 via the wireless link 204. The deactivation acknowledgment message 508 may be included, for example, as part of a Downlink Control Information (DCI) message. The deactivation acknowledgement message 508 may contain data or information relevant to post-deactivation transmission configurations of the primary base station 206 and the secondary base station 210 and allow the user device 102 to reconfigure itself for data reception accordingly. After receipt of the deactivation acknowledgement message 508, the user device 102 may terminate carrier aggregation operations it may be performing to mitigate the power condition local to the user device 102.

In a complementary fashion, and after the user device determines the power condition no longer exists, data and control transactions directed to activation may occur amongst devices. As illustrated, such data and control transactions may include an activation message 510 that includes data or commands to activate high-bandwidth data transmission, an activation configuration message 512, an activation confirmation message 514, and an activation acknowledgement message 516.

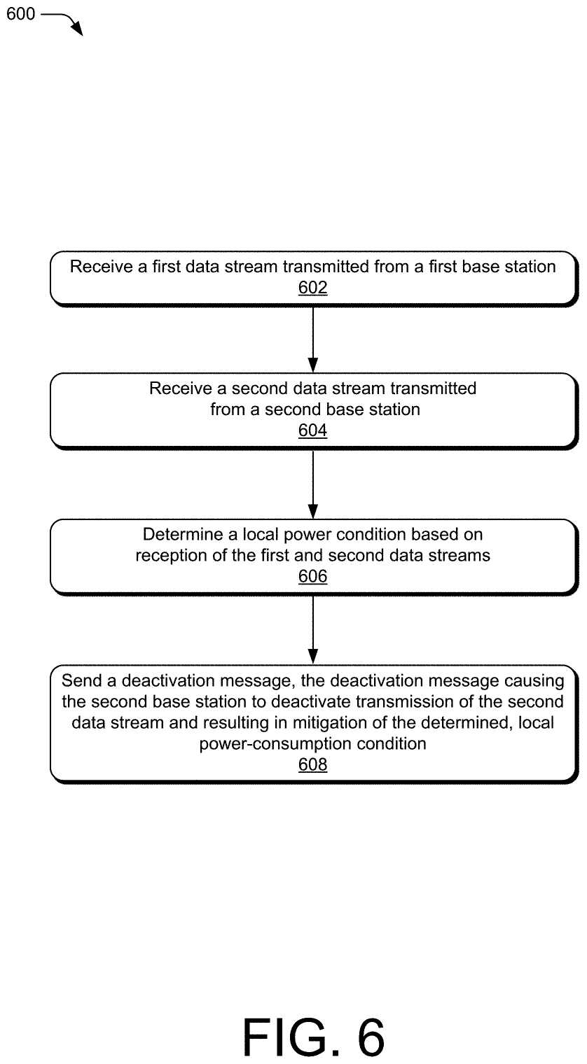

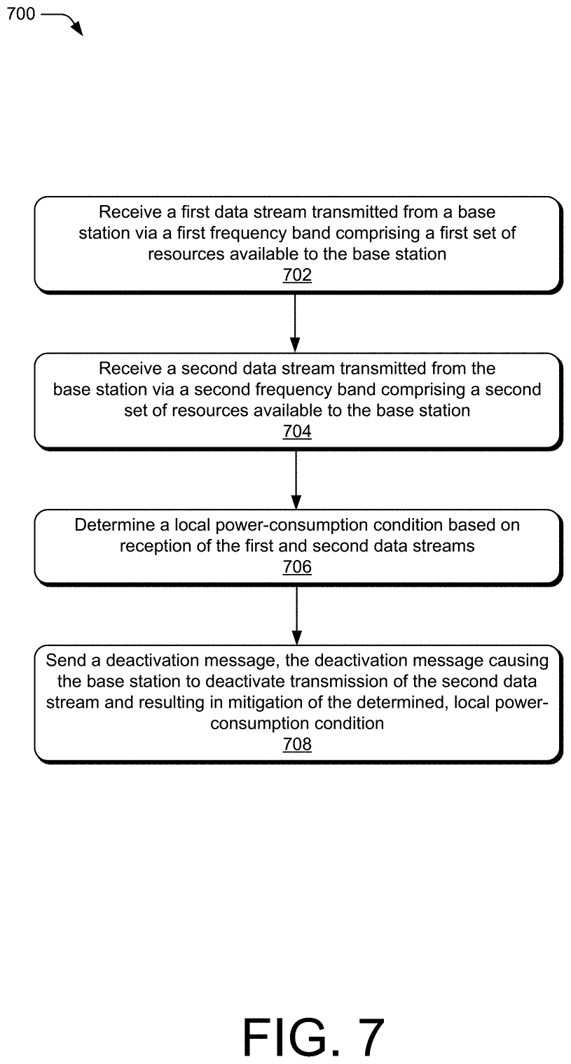

Example methods 600 and 700 are described with reference to FIGS. 6 and 7 in accordance with one or more aspects of mitigating a power condition by deactivating high-bandwidth transmission of data. Generally, any of the components, modules, methods, and operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 6 illustrates an example method 600 of mitigating a power condition that is local to a user device as generally related to high-bandwidth transmission of data through multi-connectivity technology. The method 600 is described in the form of a set of blocks 602-608 that specify operations that can be performed by user device, such as the user device 102 of FIG. 1. However, operations are not necessarily limited to the order shown in FIG. 6 or described herein, for the operations may be implemented in alternative orders or in fully or partially overlapping manners. Operations represented by the method 600 may be performed by the user device 102 and performed using elements of FIGS. 1-5.

At 602, a user device (e.g., the user device 102) receives a first data stream transmitted from a first base station (e.g., the primary base station 206) to which the user device is wirelessly connected via a first wireless link (e.g., the wireless link 204). At 604, the user device receives a second data stream transmitted from a second base station (e.g., the secondary base station 210) to which the user device is wirelessly connected via a second wireless link (e.g., the wireless link 208).

In some instances, and as part of high-bandwidth communications, the first and second data streams are simultaneously transmitted, respectively, by the first and second base stations. In such instances, the first and second data streams may be simultaneously transmitted in accordance with orthogonal multiple access (OMA) or non-orthogonal multiple access (NOMA) protocols and the user device may, upon receiving the first and second data streams, perform carrier aggregation operations that combine the first and second data streams.

At 606, the user device determines a local power condition based on the user device receiving the first and second data streams. Determination of the local power condition may be performed by combining functionalities of detection circuitry of the user device (e.g., the detection circuitry 116) with functionalities of a processor (e.g., the processor 118) executing code or instructions stored in computer-readable storage media (e.g., the power-condition manager 122 stored in the CRM 120). The determined local power condition may be associated to one or more of a detected temperature of the user device, a detected electrical-current draw of the user device, or a detected strength of a signal transmitting from the user device.

At 608, the user device may send a deactivation message (e.g., the deactivation message 502 of FIG. 5) that causes the second base station to deactivate the transmission of the second data stream, resulting in mitigation of the determined, local power condition. The deactivation message may be included as part of a Radio Resource Control (RRC) message, a Medium Access Control Element (MAC CE) message, an Uplink Control Information (UCI) message, or a Buffer Status Report message that is transmitted from the user device to the base station. In certain instances, the deactivation message may be sent to the first base station, which in turn relays the deactivation message to the base station, while in other instances the deactivation may be sent to the second base station.

The example method 600 may, in general, further include operations that determine the local power condition no longer exists and, in response, send an activation message that reactivates transmission of data from the second base station.

FIG. 7 illustrates an example method 700 of mitigating a power condition that is local to a user device as generally related to high-bandwidth transmission of data relying on differing bandwidth parts of a wireless link. The method 700 is described in the form of a set of blocks 702-708 that specify operations that can be performed by user device, such as the user device 102 of FIG. 1. However, operations are not necessarily limited to the order shown in FIG. 7 or described herein, for the operations may be implemented in alternative orders or in fully or partially overlapping manners. Operations represented by the method 700 may be performed by the user device 102 and performed using elements of FIGS. 1-5.

At 702, a user device (e.g., the user device 102) receives a first data stream transmitted from a base station (e.g., the base station 106) via a first frequency band comprising a first set of resources (e.g., a bandwidth part corresponding to the subcarrier group 314) available to the base station. At 704, a user device receives a second data stream transmitted from a base station via a second frequency band comprising a second set of resources (e.g., another bandwidth part corresponding to the subcarrier group 316) available to the base station.

In some cases, and as part of high-bandwidth communications, the first and second data streams are simultaneously transmitted by the first base station. In this instance, and upon receiving the simultaneously transmitted first and second data streams, the user device may perform carrier aggregation operations that combine the first and second data streams.

At 706, the user device determines a local power condition based on the user device receiving the first and second data streams. Determination of the local power condition may be performed by combining functionalities of detection circuitry of the user device (e.g., the detection circuitry 116) with functionalities of a processor (e.g., the processor 118) executing code or instructions stored in computer-readable storage media (e.g., the power-condition manager 122 stored in the CRM 120). The determined local power condition may be related to one or more of a detected temperature of the user device, a detected electrical-current draw of the user device, or a detected strength of a signal transmitting from the user device.

At 708, the user device may send a deactivation message (e.g., the deactivation message 502 of FIG. 5) that causes the base station to deactivate transmission of the second data stream (e.g., deactivate transmissions via the subcarrier group 316). The deactivation message may include data or commands and may also be included as part of a Radio Resource Control (RRC) message, a Medium Access Control Element (MAC CE) message, an Uplink Control Information (UCI) message, or a Buffer Status Report message that is transmitted from the user device to the base station.

Many permutations and combinations of techniques illustrated and described by FIGS. 5-7 exist. Permutations may include, for example, a plurality of base stations transmitting multiple data streams using multiple, respective bandwidth parts available through an air-interface resource, one or more base stations performing transmission operations in accordance with orthogonal multiple access (OMA) protocols, one or more base stations performing transmission operations in accordance with non-orthogonal multiple access (NOMA) protocols, and so forth.

1. A method for mitigating a power condition that is local to a user device, the user device using multi-connectivity technology to receive multiple data streams, the method comprising:
receiving, by the user device, a first data stream transmitted from a first base station to which the user device is wirelessly connected via a first wireless link;
receiving, by the user device, a second data stream transmitted from a second base station to which the user device is wirelessly connected via a second wireless link;
determining, by the user device using detection circuitry of the user device, a local power condition during reception of the first and second data streams; and
sending, by the user device, a deactivation message, the deactivation message causing the second base station to deactivate the transmission of the second data stream.

2. The method as recited in claim 1, wherein the first and second data streams are concurrently received by the user device.

3. The method as recited in claim 2, wherein the first and second data streams are concurrently received in accordance with orthogonal multiple access (OMA) or non-orthogonal multiple access (NOMA) protocols, each respectively.

4. The method as recited in claim 2, wherein the user device, upon receiving the first and second data streams, performs carrier aggregation operations that aggregate the first and second data streams.

5. The method as recited in claim 1, wherein the local power condition is associated to one or more of a detected temperature of the user device, a detected electrical-current draw of the user device, or a detected strength of a signal transmitting from the user device.

6. The method as recited in claim 1, wherein the deactivation message is included as part of a Radio Resource Control (RRC) message, a Medium Access Control Element (MAC CE) message, an Uplink Control Information (UCI) message, or a Buffer Status Report message.

7. The method as recited in claim 1, wherein the deactivation message is sent, by the user device, to the first base station.

8. The method as recited in claim 1, wherein the deactivation message is sent, by the user device, to the second base station.

9. The method as recited in claim 1, further including operations of determining that the local power condition no longer exists and, in response, sending an activation message that reactivates transmission of data from the second base station.

10. A method for mitigating a power condition that is local to a user device, the user device using multi-connectivity technology to receive multiple data streams, the method comprising:
receiving, by the user device and from a base station to which the user device is wirelessly connected, a first data stream transmitted by the base station via a first frequency band comprising a first set of resources available to the base station;
receiving, by the user device and also from the base station, a second data stream transmitted by the base station via a second frequency band comprising a second set of resources available to the base station;
determining, by the user device using detection circuitry of the user device, a local power condition during reception of the first and second data streams; and
sending, by the user device and to the base station, a deactivation message, the deactivation message causing the base station to deactivate the transmission of the second data stream.

11. The method as recited in claim 10, wherein the first and second data streams are concurrently received by the user device.

12. The method as recited in claim 11, wherein the user device performs carrier aggregation operations that aggregate the first and second data streams.

13. The method as recited in claim 10, wherein the power condition is associated to one or more of a detected temperature of the user device, a detected electrical-current draw of the user device, or a detected strength of a signal transmitting from the user device.

14. The method as recited in claim 10, wherein the deactivation message is included as part of a Radio Resource Control (RRC) message, a Medium Access Control Element (MAC CE) message, an Uplink Control Information (UCI) message, or a Buffer Status Report message.

15. A user device comprising:
a transceiver;
detection circuitry; and
a processor and computer-readable storage media comprising instructions to implement a power-condition manager application, the power-condition manager application configured to cause the user device to:
receive, using multi-connectivity technology and through the transceiver, a first data stream and a second data stream;
determine, using the detection circuitry and during reception of the first and second data streams, a power condition that is local to the user device;
send, to a source of the second data stream, a deactivation message, the deactivation message causing the source to deactivate transmission of the second data stream.

16. (canceled)

17. The user device as recited in claim 15, wherein the detection circuitry detects an electrical-current draw from a power source of the user device, a temperature of the user device, or strength of a transmission signal of the user device.

18. The user device as recited in claim 15, wherein the power-condition manager is further configured to cause the user device to terminate carrier aggregation operations being performed by the user device.

19. The user device as recited in claim 15, wherein the power-condition manager application is further configured to cause the user device to display, via a graphical user interface (GUI), features that enable a user of the user device to manage high-bandwidth data communications.

20. The user device as recited in claim 19, wherein the features may include one or more power status indicators, a selectable menu for selecting a mode of deactivation, a selectable menu for viewing or adjusting thresholds associated with the power condition, or a selectable menu for canceling deactivation.

21. The method as recited in claim 1, wherein:
the first data stream received by the user device is received in accordance with a first communication standard; and
the second data stream received by the user device is received in accordance with a second communication standard, wherein the second communication standard is different than the first communication standard.
